(19) United States
(12) Patent Application Publication
(10) Pub. No.: US 2026/0056334 A1
(43) Pub. Date: Feb. 26, 2026

(54) RADIOGRAPHIC IMAGING APPARATUS

(71) Applicant: Konica Minolta, Inc., Tokyo (JP)

(72) Inventors: Junichiro OTAKI, Tokyo (JP); Hajime ISHIMOTO, Tokyo (JP)

(21) Appl. No.: 19/170,460

(22) Filed: Apr. 4, 2025

(30) Foreign Application Priority Data
Apr. 8, 2024 (JP) 2024-062154

(51) Int. Cl. G01T 1/20

(52) U.S. Cl. CPC G01T 1/20188; G01T 1/20184

(57) ABSTRACT

A radiographic imaging apparatus includes a radiation detection panel that detects radiation transmitted through a subject and converts the radiation into radiographic image information, an electric circuit that forms an image based on the radiographic image information, a housing that houses the radiation detection panel and the electric circuit, and an operation receiver that includes a substrate and is attached to the housing. The substrate of the operation receiver and the housing are insulated from one another by an insulator.

### CROSS-REFERENCE TO RELATED APPLICATIONS

The present invention claims priority under 35 U.S. C. § 119 to Japanese Patent Application No. 2024-062154, filed on Apr. 8, 2024, the entire content of which is incorporated herein by reference.

### BACKGROUND OF THE INVENTION

### TECHNICAL FIELD

The present invention relates to a radiographic imaging apparatus.

### DESCRIPTION OF RELATED ART

Conventionally, there has been known a radiographic imaging apparatus that irradiates an object with radiation, detects an intensity distribution of the radiation transmitted through the object, and captures a radiographic image. Radiographic imaging apparatuses are widely used in the medical field, the industrial field, and the like. In recent years, a portable (cassette-type) radiographic imaging apparatus that can be separated from an imaging stand and carried has been developed and put to practical use. Since such a radiographic imaging apparatus has a panel shape, it may be referred to as a flat panel detector (FPD). The FPD includes therein a radiation detection panel for detecting radiation.

A portable FPD may be used for portable imaging in which a user carries the FPD and inserts it between a bed in a hospital ward and a patient to perform X-ray imaging. In the case of portable imaging, the portable FPD may be in a so-called two side supported and bent state depending on the situation. The two side supported and bent state is a state in which a load is applied to the vicinity of the center while two opposite sides of the FPD performs supporting.

The FPD is provided with an operation part used for On/Off operations of a power source and cooperative operations with an external apparatus. The operation part may be provided with a display part for displaying the states of the power source and the cooperation. The operation part is provided by cutting a housing and therefore is lower in strength than other parts. Therefore, when the portable FPD is in the two side supported and bent state, bending stress concentrates on the operation part.

In addition, in the portable FPD, when electric charges are accumulated due to friction with a bed or the like, or electric charges are accumulated in a user or a patient, discharge of static electricity may occur.

Therefore, Japanese Unexamined Patent Publication No. 2022-143666 discloses a configuration in which at least a part of an operation part is made of metal such as iron or aluminum to suppress deformation and damage. In the configuration of Japanese Unexamined Patent Publication No. 2022-143666, a part of the operation part is made of metal and is brought into contact with the housing or is electrically connected with the housing via a screw or the like. Thus, the electric charges discharged to the operation part are released to the ground through the housing.

### SUMMARY OF THE INVENTION

However, in the configuration described in Japanese Unexamined Patent Publication No. 2022-143666, when the voltage of the electrostatic discharge is large, the electric charges may flow not only to the housing but also to electric circuits and image detecting elements in the vicinity to affect them.

Furthermore, since buttons and a display part of the operation part are connected to an internal electric substrate from a substrate of the operation part through wiring (lines), a large voltage fluctuation due to the discharge from the housing is transmitted to the electric substrate. When a large voltage fluctuation due to the discharge is transmitted to the electric substrate, the electric substrate may be broken or may generate large noise even if the electric substrate is not broken, which may cause an image defect or a malfunction.

An object of the present invention is to provide a radiographic imaging apparatus capable of suppressing adverse effects due to electrostatic discharge.

To achieve at least one of the abovementioned objects, according to an aspect of the present invention, a radiographic imaging apparatus reflecting one aspect of the present invention includes:
a radiation detection panel that detects radiation transmitted through a subject and converts the radiation into radiographic image information;
an electric circuit that forms an image based on the radiographic image information;
a housing that houses the radiation detection panel and the electric circuit; and
an operation receiver that includes a substrate and is attached to the housing,
wherein the substrate of the operation receiver and the housing are insulated from one another by an insulator.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: FIG. 1 is a perspective view illustrating an appearance of a radiographic imaging apparatus according to the present embodiment;

FIG. 2 is a sectional view taken along line II-II of FIG. 1;

FIG. 3 is a side view of an operation part;

FIG. 4 is a diagram illustrating an example of a state in which the operation part is to be attached to a lateral surface of a housing from the outside;

FIG. 5 is a diagram illustrating an example in which the operation part is attached to an inclined surface that inclines from the back surface to the lateral surface of the housing;

FIG. 6 is a diagram illustrating an example in which the operation part is attached so as to straddle two surfaces of the lateral surface and the back surface of the housing;

FIG. 7 is a sectional view illustrating an example in which the operation part is attached to the inner side of the lateral surface of the housing;

FIG. 8 is a diagram of the operation part attached to the inner side of the lateral surface of the housing as viewed from the outer side of the lateral surface;

FIG. 9 is a diagram illustrating an example in which gripping parts are provided on the back surface of the housing; and
FIG. 10 is a diagram illustrating an example in which a circumferential gripping part is provided on the back surface of the housing.

### DETAILED DESCRIPTION

Hereinafter, one or more embodiments of the present invention will be described in detail with reference to the drawings. However, the scope of the invention is not limited to the disclosed embodiments.

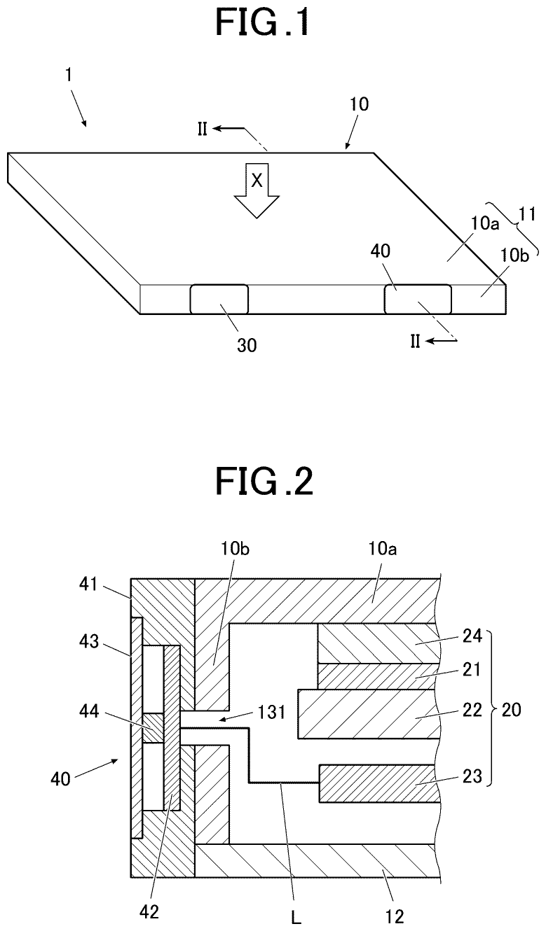

As illustrated in FIG. 1, a radiographic imaging apparatus 1 according to the present embodiment includes a housing 10. As illustrated in FIG. 2, an internal module 20 is housed in the housing 10.

The housing 10 is made of, for example, a carbon fiber reinforced resin (CFRP). The housing 10 is configured to be divided into a box-shaped front plate 11 having a front surface 10a that is an irradiation surface with radiation X and a lateral surface 10b, and a back plate 12 as a cover. The front plate 11 and the back plate 12 are fastened to each other with, for example, screws and can be easily separated from each other. A waterproof member, such as a gasket (not illustrated), is provided at a joint between the front plate 11 and the back plate 12 so as to prevent liquid from entering the inside. Note that the lateral surface 10b of the housing 10 may be formed integrally with the back plate 12 instead of the front plate 11. Alternatively, a frame that is a separate member from the front plate 11 and the back plate 12 may be joined to the front plate 11 or the back plate 12 as the lateral surface 10b of the housing 10.

As illustrated in FIG. 2, the internal module 20 includes a radiation detection panel 21, a support 22, a control substrate 23, and a spacer 24.

The radiation detection panel 21 detects radiation transmitted through a subject and converts the radiation into radiographic image information. The radiation detection panel 21 is formed by, for example, stacking and sealing a scintillator and a flexible thin film transistor (TFT). The flexible TFT includes TFTs, which are semiconductor elements and switch elements, arranged in a matrix on an imaging surface of a flexible substrate. The imaging surface of the substrate is a surface to be irradiated with radiation.

When the radiation detection panel 21 is irradiated with radiation, first, the scintillator emits light corresponding to the intensity of the radiation. Next, the semiconductor elements (photodiodes) on the flexible TFT convert the light emitted by the scintillator into electric charges and output the charges as signals to the control substrate 23.

The support 22 is a support base material that supports the radiation detection panel 21, the control substrate 23, and the like. The support 22 supports the radiation detection panel 21 on a first surface and the control substrate 23 on a second surface opposite to the first surface. The support 22 may be fixed to the inner surface of the housing 10 with an adhesive or a sticky substance. A positioning member (not illustrated) may be provided between the housing 10 and the support 22 to prevent the support 22 from moving.

The control substrate 23 includes a processing circuit including a CPU, a ROM, a RAM, a communication section, and the like. The processing circuit controls drive of the radiation detection panel 21 and processes signals read out from the radiation detection panel 21. Specifically, the processing circuit generates image data from signals read out from the radiation detection panel 21, and outputs the image data to a console or the like (not illustrated). That is, the control substrate 23 functions as an electric circuit of the present invention to form an image based on the radiographic image information obtained by the conversion performed by the radiation detection panel 21.

The spacer 24 is a buffer material attached between the radiation detection panel 21 and the front plate 11 of the housing 10.

In the radiographic imaging apparatus 1, a connecting part 30 and an operation part 40 (operation receiver) are provided on the lateral surface 10b of the housing 10 (in FIG. 1).

The connecting part 30 can supply power from an external apparatus by wired connection and also can be connected to an external connector for communication with an external apparatus. The connecting part 30 is connected to the control substrate 23 via the wiring, and outputs power and/or communication signals from the outside to the control substrate 23.

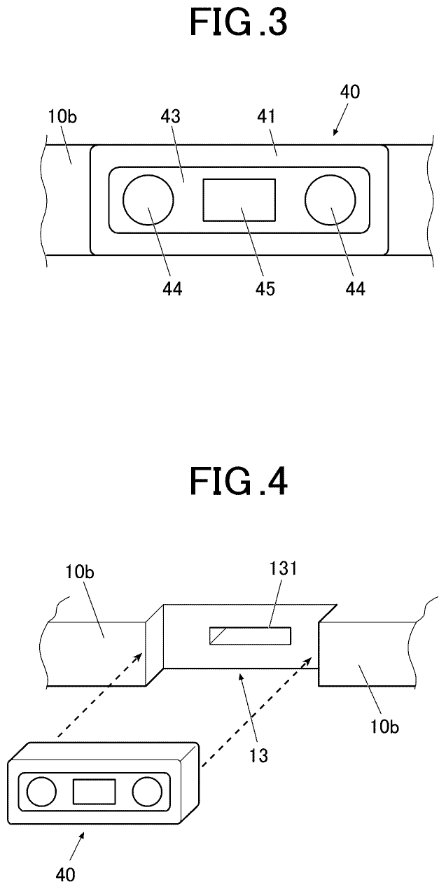

As illustrated in FIG. 2 and FIG. 3, the operation part 40 includes a frame 41, a substrate 42, a protection member 43, a plurality of switches 44, and a display part 45 (display). The substrate 42 is attached to the frame 41, and the protection member 43 is attached so as to cover the substrate 42. The substrate 42 is provided with the switches 44 and the display part 45. The operation part 40 is connected to the control substrate 23 via a line L, and outputs input operation signals to the control substrate 23.

The operation part 40 is attached to the lateral surface 10b of the housing 10 from the outside. As illustrated in FIG. 4, the lateral surface 10b of the housing 10 is provided with a recess 13 cut to be the same shape as a unit constituting the operation part 40. The operation part 40 is attached to the recess 13 with a screw (not illustrated). By configuring the operation part 40 as described above, the user can replace the operation part 40 as a unit without disassembling the housing in the case of repair or the like. That is, the operation part 40 is attached to the housing 10 to be replaceable.

The recess 13 is provided with an opening 131 (in FIG. 2 and FIG. 4). The line L connected to the substrate 42 of the operation part 40 is connected to the control substrate 23 inside the housing 10 through the opening 131.

The frame 41 is engaged with the housing 10. The frame 41 is configured such that the substrate 42 can be attached thereto. The frame 41 is made of an insulator. Thus, the substrate 42 of the operation part 40 and the housing 10 are insulated from each other by the insulator (frame 41).

Examples of the material of the frame 41 include polyolefins, ABS, which are general resins, engineering plastics, and super engineering plastics. Examples of the engineering plastics include polyamide, polycarbonate, and polybutylene terephthalate.

Examples of the super engineering plastics include polyimide, polyamide-imide, and polyphenylene sulfide. A fiber-reinforced resin (FRP) obtained by reinforcing the above with glass fibers or the like may be used. For example, in the case where polyamide-imide reinforced with glass fibers is used, sufficient strength is obtained also against bending in which a human body is on in the two side supported state.

The material of the frame 41 is not limited to resin and may be any material as long as it has a strength to withstand a load during use and has an insulating property. For example, ceramic or the like may be used.

The protection member 43, the switches 44, the display part 45, and the like are made of an insulating member, such as resin. That is, a part of the operation part 40, including the frame 41, exposed to the outer surface of the housing 10 is made of an insulator. This can prevent discharge due to static electricity.

Note that a waterproof member such as an O-ring or a gasket may be provided between the frame 41 and the housing 10. The frame 41 may be adhered to the housing 10.

This can prevent water and dust from entering the housing 10 from the periphery of the operation part 40.

The switches 44 include, for example, a switch for turning on and off the power source and a switch(es) for operating various functions. Each switch 44 is configured, for example, in a form in which a mechanical switch element attached to the substrate 42 is covered with the protection member 43 such as a resin film. Alternatively, each switch 44 may be a thin-film shaped line such as a membrane switch.

The display part 45 displays the state of the radiographic imaging apparatus 1. The display part 45 may be a simple lamp or a 7LED, or may be a small display composed of, for example, liquid crystal and LED pixels. The display part 45 displays an apparatus state such as standby or shooting, the number of images stored in a built-in memory, the remaining life of a rechargeable battery, an error number at the time of abnormality, and the like. Note that two or more separate display parts 45 corresponding to display contents may be provided.

As described above, the radiographic imaging apparatus 1 according to the present embodiment includes the radiation detection panel 21 that detects radiation transmitted through a subject and converts the radiation into radiographic image information, the electric circuit (control substrate 23) that forms an image based on the radiographic image information obtained by the conversion performed by the radiation detection panel 21, and the housing 10 that houses the radiation detection panel 21 and the electric circuit. The operation part 40 including the substrate 42 is attached to the housing 10. The substrate 42 of the operation part 40 and the housing 10 are insulated from each other by an insulator.

Therefore, according to the radiographic imaging apparatus 1 of the present embodiment, the housing 10 and the substrate 42 of the operation part 40 can be insulated from each other. Accordingly, even when electrostatic discharge occurs in the housing 10, it is possible to suppress adverse effects on the electric circuit inside the housing 10 through the substrate 42. Thus, adverse effects due to electrostatic discharge can be suppressed.

Furthermore, the operation part 40 includes the frame 41 that is engaged with the housing 10 and to which the substrate 42 is attachable. The frame 41 is made of an insulator. The operation part 40 further includes the switches 44 and the display part 45.

Therefore, the housing 10 and the substrate 42 of the operation part 40 can be insulated from each other. Thus, adverse effects due to electrostatic discharge can be suppressed.

A part of the operation part 40 exposed to the outer surface of the housing 10 is made of an insulator.

Therefore, it is possible to suppress occurrence of electrostatic discharge in the operation part 40, which is frequently touched by the user. Thus, adverse effects due to electrostatic discharge can be suppressed more reliably.

The operation part 40 is attached to the lateral surface 10b of the housing 10. The operation part 40 is attached to the housing 10 to be replaceable.

Therefore, the user can easily operate and replace the operation part 40. Thus, convenience of the user can be improved.

Although the present invention has been described in detail based on one or more embodiments, the present invention is not limited to the above-described embodiments. The embodiments can be modified without departing from the scope of the present invention.

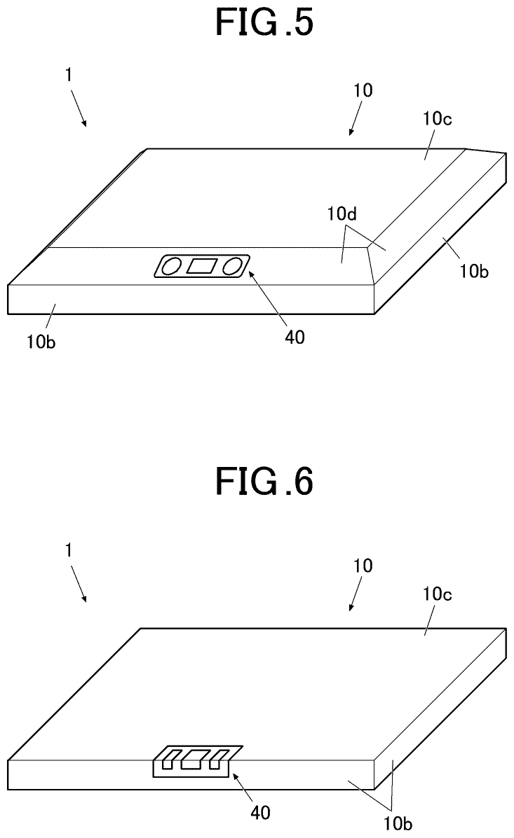

For example, although the operation part 40 is attached to the lateral surface 10b of the housing 10 in the embodiment described above, it is not limited thereto. For example, instead of being attached to the lateral surface 10b of the housing 10, it may be attached to a location other than the imaging region of the front surface (irradiation surface) 10a or to the back surface 10c. As illustrated in FIG. 5, an inclined surface 10c inclined from the back surface 10b to the lateral surface 10d may be provided, and the operation part 40 may be attached to the inclined surface 10d. As illustrated in FIG. 6, the operation part 40 may be disposed so as to straddle two surfaces of the lateral surface 10b and the back surface 10c. Of course, it may be disposed so as to straddle two surfaces of the lateral surface 10b and the front surface 10a.

Furthermore, in the above-described embodiment, the display part 45 is an example of the component that notifies the user of the state of the radiographic imaging apparatus 1, but the component is not limited thereto. That is, instead of the display part 45 or in addition to the display part 45, a component that performs the notification recognized with the sense of hearing or the sense of touch may be used. For example, a speaker may be provided to perform the notification recognized with the sense of hearing, for example, by alarm sound or voice. In this case, the speaker functions as a sound output section (sound outputter) of the present invention to output the display contents of the display part 45 by sound. The notification recognized with the sense of touch may be performed by causing the surface to protrude and return in a predetermined region. The notification recognized with the sense of touch may be performed by two dimensionally expressing braille in a predetermined region. Since the radiographic imaging apparatus is hidden under the subject in the case of portable imaging using the radiographic imaging apparatus 1, the above-described notification recognized not with the sense of sight by another is effective.

As described above, by providing the sound output section that outputs the display contents of the display part 45 by sound, it is possible to notify the user of the display contents even in a situation where it is difficult to visually recognize the display part 45. Thus, the convenience of the user can be improved.

Although the above-described various types of notification may be performed always, the notification may be stopped after a predetermined time elapses in order to prevent consumption of the rechargeable battery or the like. In this case, the notification may be resumed in response to a predetermined operation. Examples of the predetermined operation include touching a predetermined place and lifting the apparatus.

Furthermore, although the operation part 40 is attached to the lateral surface 10b of the housing 10 from the outside in the embodiment described above, it is not limited thereto. For example, an operation part 40A may be attached to the lateral surface 10b of the housing 10 from the inside.

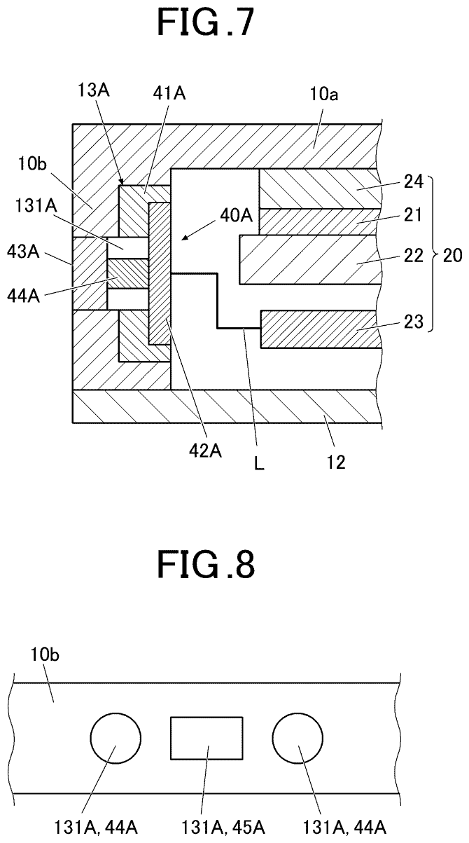

To be more specific, as illustrated in FIG. 7, the inner side of the lateral surface 10b of the housing 10 may be provided with a recess 13A cut to be the same shape as a unit constituting the operation part 40A. The operation part 40A is attached to the recess 13A with a screw (not illustrated). The recess 13A is provided with openings 131A (in FIG. 7 and FIG. 8) corresponding to the sizes of switches 44A and a display part 45A. Through the openings 131A, operations with the switches 44A and visual recognition of the display part 45A are performed.

That is, only the openings 131A are provided in the outer side of the lateral surface 10b of the housing 10 (in FIG. 8). Thus, the cut portion of the lateral surface 10b of the housing 10 can be reduced in size.

Furthermore, the outer side of the lateral surface 10b can be configured as a one face. Therefore, the strength of the housing 10 can be improved. Furthermore, since the operation part 40A can be fitted into the recess 13A, a space in the housing 10 can be secured. A protection member 43A is fitted into the opening 131A from the outer side of the lateral surface 10b so as to cover the switch 44A or the display part 45A.

With the above-described configuration too, the substrate 42A is provided at an insulating frame 41A, so that the substrate 42A is insulated from the housing 10. Therefore, even if the housing 10 is made of a conductive material (e.g., metal or CFRP), it is possible to prevent electric charges externally discharged to the housing 10 from reaching the substrate 42A or the internal control substrate 23.

Note that the operation part 40 may be attached to the inner side of the lateral surface 10b of the housing 10 without providing the recess 13. In this case, only the openings 131 are provided in the lateral surface 10b of the housing 10. The substrate 42 of the operation part 40 and the housing 10 are insulated from each other by an insulator (frame 41).

Although the operation part 40A is attached to the lateral surface 10b of the housing 10 from the inside in the above-described configuration, it is not limited thereto. For example, the operation part 40A may be attached to the back surface 10c from the inside instead of the lateral surface 10b. The operation part 40A may be attached, from the inside to the inclined surface 10d formed between the lateral surface 10b and the back surface 10c of the housing 10. That is, the operation part 40A may be attached to the inner surface of the housing 10.

The operation part 40A attached to the inner surface of the housing 10 can improve the strength of the housing 10. Therefore, deformation of and damage to the housing 10 can be suppressed.

Furthermore, in the above-described embodiment, one operation part 40 includes the switches 44 and the display part 45 but not limited thereto. For example, two or more operation parts 40 may be provided, and the switches 44 and the display part 45 may be separately provided in different operation parts 40. In this case too, an insulator (frame 41) may be provided between the substrate 42 of each operation part 40 and the housing 10.

Furthermore, as illustrated in FIG. 9, gripping parts 50 to be gripped by the user may be provided on the back surface 10c of the housing 10. The gripping parts 50 are each configured, for example, to be provided with a nonslip member attached thereto or to be provided with a recess recessed toward the inner surface. By providing the gripping parts 50, it is possible to prevent the radiographic imaging apparatus 1 from dropping by slipping out of the user's hand while it is being carried. The gripping parts 50 are preferably provided in the vicinity of the lateral surface 10b to get user's fingers caught therein to carry the radiographic imaging apparatus 1. For example, four gripping parts 50 are provided at the center of each side (in FIG. 9). The gripping part 50 near the side where the operation part 40 is provided is preferably disposed so as not to overlap the operation part 40 as viewed from the lateral surface 10b on which the operation part 40 is provided. Thus, when the user holds the apparatus, it is possible to prevent the switches 44 of the operation part 40 from being erroneously pressed.

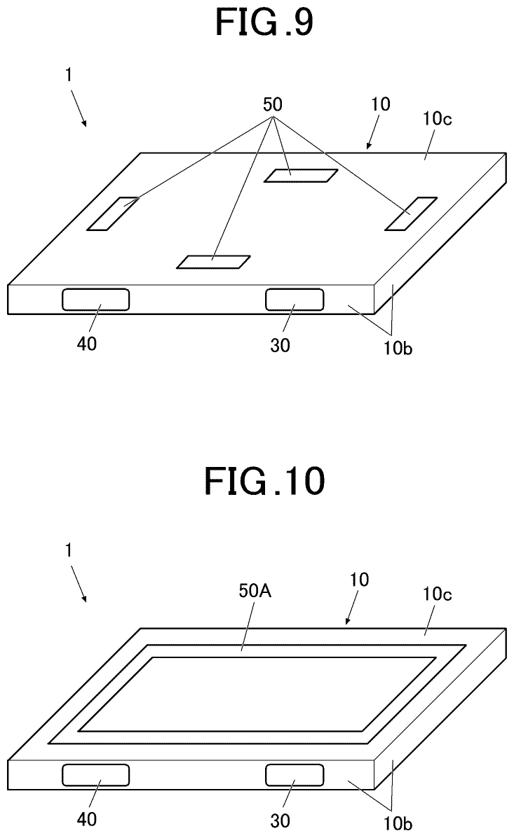

Furthermore, as illustrated in FIG. 10, a gripping part 50A, which is configured by the gripping parts 50 connected with each other, may be provided circumferentially along the four sides. Providing the circumferential gripping part 50A makes it easy to hold the apparatus from any direction. In this case, since the user may hold the apparatus from above the operation part 40, it is preferable that the outer surface of the protection member 43 for the switches 44 recedes inward from the outer surface of the housing 10. Thus, when the user holds the apparatus, it is possible to prevent the switches 44 of the operation part 40 from being erroneously pressed.

Besides, the detailed configuration and the detailed operation of each component constituting the radiographic imaging apparatus can be appropriately changed without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A radiographic imaging apparatus comprising:
a radiation detection panel that detects radiation transmitted through a subject and converts the radiation into radiographic image information;
an electric circuit that forms an image based on the radiographic image information;
a housing that houses the radiation detection panel and the electric circuit; and
an operation receiver that includes a substrate and is attached to the housing,
wherein the substrate of the operation receiver and the housing are insulated from one another by an insulator.

2. The radiographic imaging apparatus according to claim 1,
wherein the operation receiver includes a frame that is engaged with the housing and to which the substrate is attachable, and
wherein the frame is made of the insulator.

3. The radiographic imaging apparatus according to claim 1, wherein the operation receiver includes a switch and a display.

4. The radiographic imaging apparatus according to claim 1,
wherein the operation receiver includes a plurality of operation receivers, and
wherein a switch and a display are separately provided in the operation receivers different from one another.

5. The radiographic imaging apparatus according to claim 3, comprising a sound outputter that outputs a display content of the display by sound.

6. The radiographic imaging apparatus according to claim 1, wherein, of the operation receiver, a part exposed to an outer surface of the housing is made of the insulator.

7. The radiographic imaging apparatus according to claim 1, wherein the operation receiver is attached to a lateral surface of the housing.

8. The radiographic imaging apparatus according to claim 1, wherein the operation receiver is attached to a back surface of the housing.

9. The radiographic imaging apparatus according to claim 1, wherein the operation receiver is attached to an inclined surface formed between a lateral surface and a back surface of the housing.

10. The radiographic imaging apparatus according to claim 1, wherein the operation receiver is attached to an inner surface of the housing.

11. The radiographic imaging apparatus according to claim 1, wherein the operation receiver is attached to the housing to be replaceable.
